(19) United States
(12) Patent Application Publication
(10) Pub. No.: US 2013/0054582 A1
(43) Pub. Date: Feb. 28, 2013

(54) APPLYING QUERY INDEPENDENT RANKING TO SEARCH

(71) Applicants: Walter Macklem, San Francisco, CA (US); Ron Yang, Santa Clara, CA (US); Susan M. Kimberlin, San Francisco, CA (US)

(72) Inventors: Walter Macklem, San Francisco, CA (US); Ron Yang, Santa Clara, CA (US); Susan M. Kimberlin, San Francisco, CA (US)

(73) Assignee: salesforce.com, inc., San Francisco, CA (US)

(21) Appl. No.: 13/371,028

(22) Filed: Feb. 10, 2012

Related U.S. Application Data
(60) Provisional application No. 61/527,496, filed on Aug. 25, 2011.

(51) Int. Cl. G06F 17/30

(52) U.S. Cl. 707/723; 707/E17.014

(57) ABSTRACT

Query independent scores are prepared and applied to search results. Search results applying query term relevance criteria are combined with query independent scores to form a combined score. The combined score may alter the original ranking using only the query scores. The query independent scores can be used to increase the combined scores of important objects, where importance measurements include frequently accessed objects, objects with more connections and/or objects that are the subject of discussion.

### PRIORITY AND RELATED APPLICATION DATA

This application claims priority to Provisional U.S. Patent App. No. 61/527,496, filed on Aug. 25, 2011, entitled “Methods and Systems for Creating and Applying Query Independent Ranking to Search” by Macklem et al., which is incorporated herein by reference in its entirety and for all purposes.

### BACKGROUND

Organizations can accumulate large amounts of information. This information may be used in performing various tasks in the organization. To facilitate the use of the information in the organization, the information can be presented in a hierarchical manner on a graphical user interface display. A user can browse the hierarchy to eventually retrieve the information they seek. For example, a user wants to look up information about a name the user found on a document. The user browses through the hierarchy starting with a company to a list of contacts to the name desired to the address information of the name desired. However, browsing may become difficult if the user is missing a piece of information, such as the company name in the prior example, or if the information set is very large. Because of these problems, users may desire to search the information instead of browsing.

Searches are often performed with a query containing desired terms. These terms may then be used to determine relevant information from within the database. The determined relevant information may be returned as query results. A user may then browse the query results until the user finds the desired information, tries another query or gives up. In some searching systems, query terms that are similar in concept, return different results. While various techniques have been employed to effectively return query results, due to the complexity of the tasks, the employed techniques are of varied success.

### SUMMARY

The present embodiments generally relate to search engines and processes, and more particularly to implementing query independent ranking of search results.

After receiving a query, a search is performed that retrieves search results with a query score for each search result. The query score can be a measurement of a match of the query to the search results. Using the search results, query independent scores are retrieved for at least some of the objects represented in the search results. Query scores are combined with associated query independent scores to form a combined score for search results having both scores. Query results are ranked according to combined scores, if available, or query scores, if not, and returned. The combined score may alter the original ranking using only the query scores, allowing query independent scores to cause more important search results to achieve a higher rank. The query independent scores can be used to increase the combined scores of important objects, where importance measurements include frequently accessed objects, objects with more connections and/or objects that are the subject of discussion.

According to one embodiment, a computer-implemented method is provided for search ranking services. Typically, the method includes, under the control of one or more computer systems configured with executable instructions, receiving a search query and preparing a first search result list based at least in part on the search query. The first search result list typically has a set of objects, each object having a base score, the base score having been computed based at least in part on the relevance of the object to the query. The method also typically includes, for each object of at least a subset of the set of the objects, the computer system retrieving a boost score, importance score or query independent score for the object and joining the base score with the boost score to form a combined score. The boost score is typically computed based at least in part on prior user interactions with the object, the prior user interactions including page views involving the object and a measurement of children beneath the object. In certain aspects, the method further includes ranking the set of object results based on the combined scores. The method can also include returning a ranked set of object results.

According to another embodiment, a computer-implemented method is provided for search ranking services. Typically, the method includes, under the control of one or more computer systems configured with executable instructions, receiving a search query and retrieving a first search result list based on terms within the search query. The first search result list typically has a set of objects, each object having a query score, the query score having been computed based at least in part on the association of the object with the query. The method also typically includes, for each object of at least a subset of the set of the objects, retrieving a query independent score associated with the object and joining the query score with a query independent score to form a combined score. The query independent score typically has been computed based at least in part on prior interactions with the object. In certain aspects, the method further includes ranking the set of object results based on the combined scores.

According to a further embodiment, a computer system for enabling query independent search scores is provided. The computer system typically includes one or more processors and memory, including instructions executable by the one or more processors. The instructions typically cause the computer to select a set of objects represented in a database to be associated with a query independent score. The instructions also typically cause the computer to, for each object in the set of objects, measure at least one statistic of query independent identifiers and calculate a query independent score. Typically, the identifiers are selected statistics of the objects in the database. The query independent score is typically based at least in part on the at least one statistic of identifiers and scaled to supplement a search engine ranking system. In certain aspects, the instructions typically cause the computer to provide the calculated query independent scores to a search engine. In certain aspects, the query independent score is typically configured to increase a ranking of an object included in search results.

According to a still further embodiment, one or more non-transitory computer-readable storage media is provided having collectively stored thereon executable instructions that, when executed by one or more processors of a computer system, cause the computer system to perform search ranking services. Typically, the instructions cause the computer system to receive a search query and retrieve a first search result list based on terms within the search query. The first search result list typically has a set of objects, each object having a query score, the query score having been computed based at least in part on the association of the object with the query. The instructions also typically cause the computer system to, for each object of at least a subset of the set of the objects, retrieve a query independent score associated with the object and join the query score with a query independent score to form a combined score. The query independent score typically has been computed based at least in part on prior interactions with the object. In certain aspects, the instructions typically cause the computer system to rank the set of object results based on combined score.

### BRIEF DESCRIPTION OF THE DRAWINGS

The included drawings are for illustrative purposes and serve only to provide examples of possible structures and process operations for one or more embodiments of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 is a block diagram depicting an embodiment of a multi-tenant data processing system;

FIG. 2 shows a system diagram of a system 300 for integrating query independent scores in searches, provided in accordance with one embodiment;

FIG. 3 shows a diagram of a webpage 400 showing query independent scores applied to search results, in accordance with one embodiment;

FIG. 4 shows a diagram of communication showing query independent scores applied to search results, in accordance with one embodiment;

FIG. 5 shows a diagram of information sources for query independent scores, in accordance with one embodiment;

FIG. 6 shows a flowchart of a query independent score preparation and application method 700, performed in accordance with one embodiment;

FIG. 7 shows a flowchart of an alternate query independent score preparation and application method 700, performed in accordance with one embodiment;

FIG. 8 shows a flowchart of a parallel query independent score preparation method 800, performed in accordance with one embodiment; and

FIG. 9 shows a flowchart of a serial query independent score preparation method 900, performed in accordance with one embodiment.

### DETAILED DESCRIPTION OF THE INVENTION

One or more embodiments presented here relate to applying query independent ranking to search for use in a computer-implemented system. The described subject matter can be implemented in the context of any computer-implemented system, such as a software-based system, a database system, a multi-tenant environment, or the like. Moreover, the described subject matter could be implemented in connection with two or more separate and distinct computer-implemented systems that cooperate and communicate with one another. One or more embodiments may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

The disclosed implementations provide for preparing and applying query independent scores to search results. Search results applying query scores are combined with query independent scores to form a combined score. The combined score may alter the original ranking using only the query scores. The query independent scores can be used to increase the combined scores of important objects, where importance measurements include frequently accessed objects, objects with more connections and/or objects that are the subject of discussion.

### A. The Multi-Tenant System

Multi-tenant cloud-based architectures have been developed to improve collaboration, integration, and community-based cooperation between customer tenants without sacrificing data security. Generally speaking, multi-tenancy refers to a system wherein a single hardware and software platform simultaneously supports multiple user groups (also referred to as “organizations” or “tenants”) from a common data store. The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

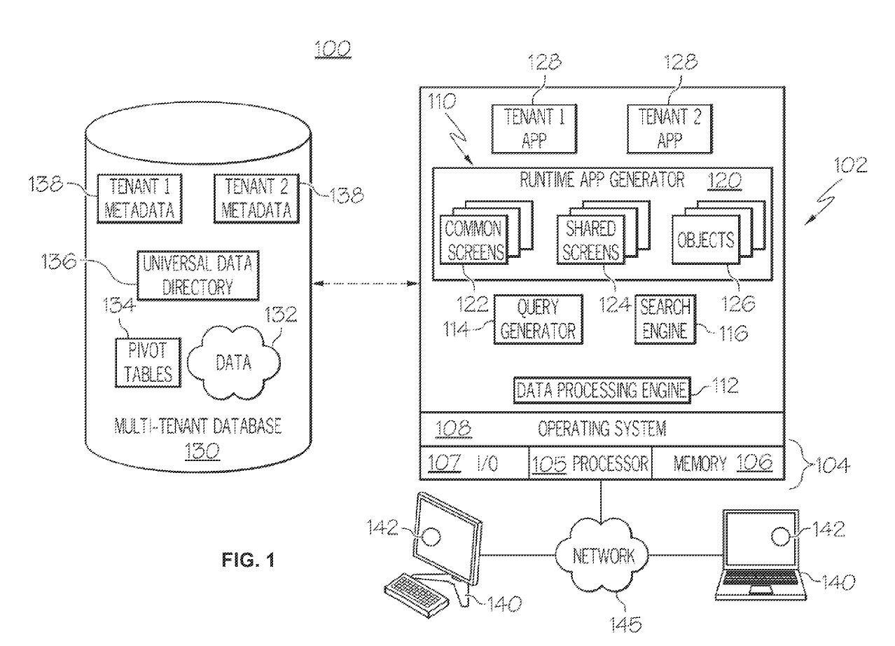

Turning now to FIG. 1, an example of a multi-tenant application system 100 may include a server 102 that dynamically creates virtual applications 128 based upon data 132 from a common database 130 that is shared between multiple tenants. Data and services generated by the virtual applications 128 are provided via a network 145 to any number of user devices 140, as desired. Each virtual application 128 is suitably generated at run-time using a common application platform 110 that securely provides access to the data 132 in the database 130 for each of the various tenants subscribing to the system 100. In accordance with one non-limiting example, the system 100 may be implemented in the form of a multi-tenant customer relationship management system that can support any number of authenticated users of multiple tenants.

A “tenant” or an “organization” generally refers to a group of users that shares access to common data within the database 130. Tenants may represent customers, customer departments, business or legal organizations, and/or any other entities that maintain data for particular sets of users within the system 100. Although multiple tenants may share access to the server 102 and the database 130, the particular data and services provided from the server 102 to each tenant can be securely isolated from those provided to other tenants. The multi-tenant architecture therefore allows different sets of users to share functionality without necessarily sharing any of the data 132.

The database 130 may represent any sort of repository or other data storage system capable of storing and managing the data 132 associated with any number of tenants. The database 130 may be implemented using any type of conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

The data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 may be organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

In an embodiment, the server 102 is implemented using one or more actual and/or virtual computing systems that collectively provide the dynamic application platform 110 for generating the virtual applications 128. The server 102 operates with any sort of conventional processing hardware 104, such as a processor 105, memory 106, input/output features 107 and the like. The processor 105 may be implemented using one or more of microprocessors, microcontrollers, processing cores and/or other computing resources spread across any number of distributed or integrated systems, including any number of “cloud-based” or other virtual systems. The memory 106 represents any non-transitory short or long term storage capable of storing programming instructions for execution on the processor 105, including any sort of random access memory (RAM), read only memory (ROM), flash memory, magnetic or optical mass storage, and/or the like. The server 102 typically includes or cooperates with some type of computer-readable media, where a tangible computer-readable medium has computer-executable instructions stored thereon. The computer-executable instructions, when read and executed by the server 102, cause the server 102 to perform certain tasks, operations, functions, and processes described in more detail herein. In this regard, the memory 106 may represent one suitable implementation of such computer-readable media. Alternatively or additionally, the server 102 could receive and cooperate with computer-readable media (not separately shown) that is realized as a portable or mobile component or platform, e.g., a portable hard drive, a USB flash drive, an optical disc, or the like.

In an embodiment, the input/output features 107 may represent conventional interfaces to networks (e.g., to the network 145, or any other local area, wide area or other network), mass storage, display devices, data entry devices and/or the like. In a typical embodiment, the application platform 110 gains access to processing resources, communications interfaces and other features of the processing hardware 104 using any sort of conventional or proprietary operating system 108. As noted above, the server 102 may be implemented using a cluster of actual and/or virtual servers operating in conjunction with each other, typically in association with conventional network communications, cluster management, load balancing and other features as appropriate.

In an embodiment, the application platform 110 may be any sort of software application or other data processing engine that generates the virtual applications 128 that provide data and/or services to the user devices 140. The virtual applications 128 are typically generated at run-time in response to queries received from the user devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user devices 140. The virtual applications 128 created by tenants are typically constructed in accordance with the tenant-specific metadata 138, which describes the particular tables, reports, interfaces and/or other features of the particular application. In various embodiments, each virtual application 128 generates dynamic web content that can be served to a browser or other client program 142 associated with its user device 140, as appropriate. As used herein, such web content represents one type of resource, data, or information that may be protected or secured using various user authentication procedures.

The runtime application generator 120 suitably interacts with the query generator 114 to efficiently obtain multi-tenant data 132 from the database 130 as needed. In a typical embodiment, the query generator 114 considers the identity of the user requesting a particular function, and then builds and executes queries to the database 130 using system-wide metadata, tenant specific metadata 138, pivot tables 134, and/or any other available resources. The query generator 114 in this example therefore maintains security of the common database 130 by ensuring that queries are consistent with access privileges granted to the user that initiated the request.

The data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc. In certain embodiments, the data processing engine 112 and the processor 105 cooperate in an appropriate manner to perform and manage the various data truncation and deletion operations.

In operation, developers may use the application platform 110 to create data-driven virtual applications 128 for the tenants that they support. Such virtual applications 128 may make use of interface features such as tenant-specific screens 124, universal screens 122 or the like. Any number of tenant-specific and/or universal objects 126 may also be available for integration into tenant-developed virtual applications 128. The data 132 associated with each virtual application 128 is provided to the database 130, as appropriate, and stored until it is requested or is otherwise needed, along with the metadata 138 that describes the particular features (e.g., reports, tables, functions, etc.) of that particular tenant-specific virtual application 128.

The data and services provided by the server 102 can be retrieved using any sort of personal computer, mobile telephone, portable device, tablet computer, or other network-enabled user device 140 that communicates via the network 145. Typically, the user operates a conventional browser or other client program 142 to contact the server 102 via the network 145 using, for example, the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. The query generator 114 suitably obtains the requested data 132 from the database 130 as needed to populate the tables, reports or other features of the particular virtual application 128. As noted above, the virtual application 128 may contain Java, ActiveX, or other content that can be presented using conventional client software running on the user device 140; other embodiments may simply provide dynamic web or other content that can be presented and viewed by the user, as desired.

An embodiment of the system 100 may leverage the query optimization techniques described in U.S. Pat. No. 7,529,728 and/or the custom entities and fields described in U.S. Pat. No. 7,779,039. The content of these related patents is incorporated by reference herein. In this regard, the multi-tenant database 130 can generally be viewed as a collection of objects, such as a set of logical tables, containing data fitted into predefined categories. Accordingly, a “table” is one representation of a database object, and tables may be used herein to simplify the conceptual description of objects and custom objects. It should be understood that “table” and “object” may be used interchangeably herein. Each table generally contains one or more data categories logically arranged as columns or fields in a viewable schema. Each row, entry, or record of a table contains an instance of data for each category defined by the fields. For example, a customer relationship management (CRM) database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided. For example, a CRM database application may provide standard entity tables for Account, Contact, Lead, and Opportunity data, each containing pre-defined fields.

### B. The Social Enterprise™

In some implementations, an online social network associated with a multi-tenant application system may allow a user to “follow” individual users, groups of users, non-human entities, and/or any of the types of objects described above. One example of such an online social network is Chatter®, provided by salesforce.com, inc.

The “following” of a record stored in a database, as described in greater detail below, allows a user to track the progress of that record. Updates to the record, also referred to herein as changes to the record, can occur and be noted on an information feed such as the record feed or the news feed of a user subscribed to the record. With the disclosed implementations, such record updates are often presented as an item or entry in the feed. Such a feed item can include a single update or a collection of individual updates. Information updates presented as feed items in an information feed can include updates to a record, as well as other types of updates such as user actions and events, as described herein. Examples of record updates include field changes in the record, as well as the creation of the record itself. Examples of other types of information updates, which may or may not be linked with a particular record depending on the specific use of the information update, include posts such as explicit text or characters submitted by a user, multimedia data sent between or among users, status updates such as updates to a user's status or updates to the status of a record, uploaded files, indications of a user's personal preferences such as “likes and “dislikes,” and links to other data or records. Information updates can also be group-related, e.g., a change to group status information for a group of which the user is one of possibly additional members. A user following, e.g., subscribed to, the record is capable of viewing record updates on the user's news feed. Any number of users can follow a record and thus view record updates in this fashion. Some records are publicly accessible, such that any user can follow the record, while other records are private, for which appropriate security clearance/permissions are a prerequisite to a user following the record.

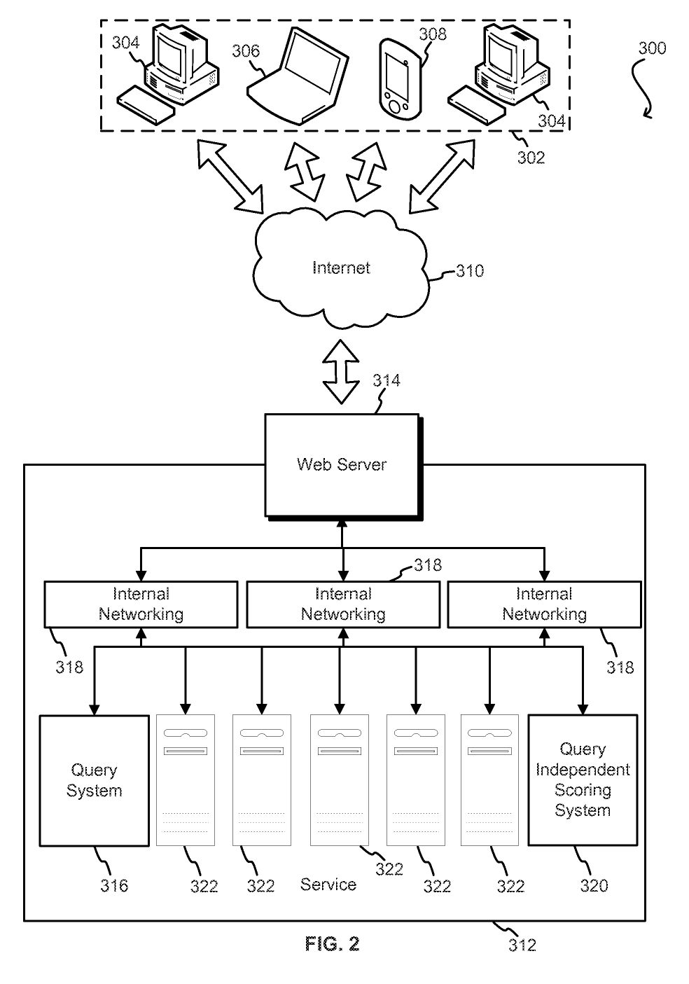

Turning now to FIG. 2, an example environment 300 in which a query independent scoring system may reside is shown. A computing system 302, such as a desktop 304, laptop 306 and/or mobile device 308 sends a query over a network, such as the internet 310, to a web service 312. The web service 312 receives the query through a web server 314 component. The web server 314 presents the query to a query system 316 that has indexed information contained within the service 312, such as servers 322 that may include databases. The query system 316 returns a set of results that references objects determined to be relevant to the query sent by the computing system 302. Each of the results have a query score. The set of results is used to request query independent scores from the query independent scoring system. The query scores and query independent scores are combined into a combined score for each of the results in the set of results. The set of results is then ranked by the combined score. The web server 314 prepares a response using the ranked set of results to return a search result page to the computing system 302.

By using query independent scores combined with query scores, more important data may rank higher, even if some data may receive a higher query score. In one embodiment, importance is measured by user interactions with objects. These interactions include measurements of numbers of children of an object, page views involving an object and social sharing (or chatter) about an object. For example, if a query included the terms “electronic pc,” the search results may be dominated by various listings for personal computer products and/or related information, as the query score would match personal computer information. However, if a client was named “Electronic PC, LLC,” the query independent score can increase the combined score because of children of the object (such as contacts and accounts), page views involving the object (such as accesses to the client object), and social sharing involving the client (such as posts and comments). The measurements of importance can also be altered to adjust for other factors including recency, freshness and popularity, such as adjusting query independent scores with a decay that rewards more current information versus past information.

In one embodiment, the query independent scoring system 320 builds query independent scores at set intervals. The query independent scoring system 320 gathers information related to numbers of children, page views involving objects and social sharing relating to objects. To gather information relating to numbers of children, objects are examined in a database for related foreign keys. In some embodiments, the foreign keys determination is limited to foreign keys that indicate importance. For example, foreign keys relating to past addresses are determined to not be relevant and therefore not counted in the number of children calculation. However, foreign keys relating to accounts are determined to be relevant in importance and counted in the number of children calculation. To gather information relating to page views relating to objects, object access logs may be examined. For example, a log may be parsed for information relating an object to a page view, such as through a Map/Reduce job. The output may be placed in a database table that maps the object access to a page view count. In the case of a multi-tenant database, the organization identifier may also be included in the mapping. In some embodiments, the page view count is stored with the object's other information. To gather information relating to social sharing, posts and comments may be examined for association with an object. For example, posts and comments are examined for relationships to objects. These relationships include links to an object within a post or comment, posts or comments within a category linked to an object, and/or media tagged or linked as related to an object.

In some embodiments, the query independent information (also known as the importance information) gathered is used to calculate the query independent score. In one embodiment, the statistics of foreign keys, page views and social shares is combined to make a query independent score. The statistics are categorized such that each statistic can receive a weighting in line with the determined importance of the statistic. These statistics can be stored in a database table. In one embodiment, the categories are foreign keys, page views and social shares. In another embodiment, the foreign keys, page views and social shares are broken into further categories, such that each category has a weight that is applied. For example, foreign keys are further categorized as accounts and contacts. Accounts may receive a higher weighting, as the number of accounts demonstrates a higher importance than number of contacts. After applying the weights, the statistics are combined to make a query independent score. In an embodiment, the query independent score is formed by adding the weighted statistics together and then normalizing the query independent score to a level of appropriate influence related the query score. In another embodiment, the weighted statistics are combined to form a query independent score which is stored and only normalized when used. In another embodiment, the weights are selected such that the combined weighted statistics result in a normalized query score. In some embodiments, the statistics and/or scores are stored with the associated object, such as in a database table describing the object. In other embodiments, the statistics and/or scores are stored together in a combined table.

In another embodiment, query independent scores dynamically update as interactions occur. For example, when an object receives a page view, its query independent score is updated to include the new page view. In other embodiments, a threshold of updates may cause a recalculation of the query independent score. For example, upon receiving 100 page views, an object's query independent score is updated. In some embodiments, a hybrid approach of query independent score recalculation is performed. In one embodiment, query independent scores are updated on a periodic basis, but single object updates to query independent scores are triggered upon exceeding a threshold. For example, a query independent scoring system gathers information and updates query independent scores nightly. However, if an object exceeds adding 10 foreign keys, 700 page views and/or 10 new social sharing of content, the query independent scoring system updates the query independent score for that object before the next scheduled update.

To reduce the amount of work required on large volumes of information, query independent score calculations may be limited to certain objects that are desired to increase in ranking in search results. In one embodiment, an administrator selects categories of objects that will have query independent scores calculated. In another embodiment, only objects having a minimum level of statistics will have a query independent score calculated. In another embodiment, a hybrid approach is taken, where only objects having a minimum level of statistics and membership in a selected category will have a query independent score calculated.

Query independent scores may be based in various statistical measurements. Statistical measurements may involve time, such as total numbers, time windows, point in time snapshots and other. Statistical measurements may include numerical summaries, such as total number of events, total number of events in a period, average, median or other summary statistics. In one embodiment, the query independent score is calculated using a base score of total user interactions combined with a score of recent interactions using a decay function to emphasize recent interactions. In another embodiment, a logarithm of the measurement is used instead of the measurement itself. The logarithm allows more sensitivity to lower scores and potentially decreases the likelihood that an object with a large number of children will have a dominating query independent score. In storing a logarithm, space savings may also be achieved because in higher ranges, lower precision is tolerated.

While the discussion about the embodiment shown in FIG. 1 has been in terms of a web page and web server, it should be recognized that other systems and communications may be used. For example, an application server may support a native application on a mobile device instead of a computer system 302 accessing a web page from a web server 314. Other configurations, including applets, AJAX and client-server implementations may be used.

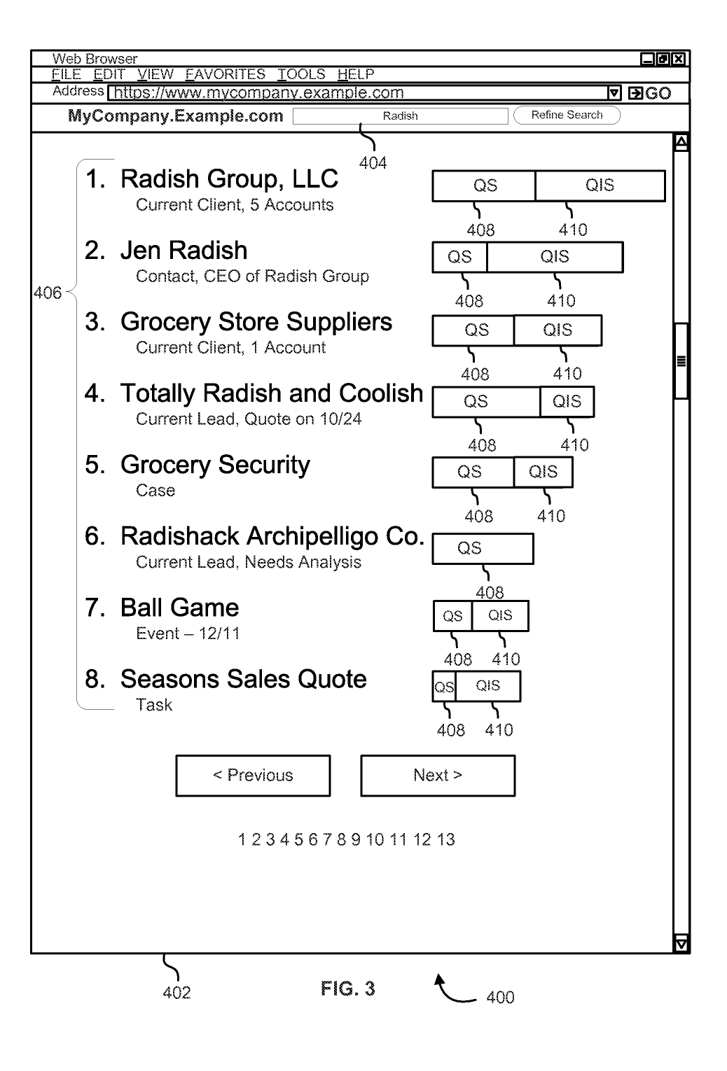

Turning now to FIG. 3, a diagram of a webpage 400 displayed within a web broser 402 showing query independent scores applied to search results is shown. In one embodiment, after receiving a query in the search box 404, ranked query results 406 are returned. The query results are associated with objects in a database. Each object received a combined score based at least in part on its query score (“QS”) 408 and its query independent score (“QIS”) 410. The scores 408 and 410 are represented by the length of bars for ease of visualization, but the bars may be omitted when displaying the results to a user. The query score is a measure of the relationship of an object to the query. The query independent score is a measure of user interaction with the object. In the embodiment shown, the number 1 result has a high QS 408 and QIS 410 because the object is very related to the query terms (QS, such as Radish in the company name) and because the object has a high number of user interactions (QIS 410, such as five accounts). The number 2 result does not have as high of a QS 408, but has a larger QIS 410 score, causing it to rise above results 3-6. The higher QIS 410 can be a result of page views and/or social sharing related to the “Jen Radish” object. As there has been more user interaction with Jen Radish, a user may likely be searching for that object rather than a static measurement against query terms. Items 7 and 8 may not have made the front page except for their QIS 410 score causing their combined score to be increased enough to make the first page of results. The QS 408 scores may be low because a few attendees have Radish in their company or contact name, but the objects may be viewed enough or discussed enough to have a high enough QIS 410 to be presented on the first page of results. In so doing, objects important to users of the database are given a higher priority than just using the QS 408 score.

While FIG. 3 shows QIS 410 scores that potentially have more influence than QS 408 scores, the QIS 410 scores can also be used to differentiate between objects with similar QS 408 scores. QIS 410 scores can be weighted to have the desired influence over QS 408 scores. In one embodiment QIS 408 scores are only reviewed if two QS 408 scores are identical. In another embodiment, the QS 408 scores are whole numbers, while QIS 410 scores are between 0 and 1. In another embodiment, QIS 410 scores are weighted to give a small influence over placement, while QS 408 scores form the majority of the weighting. In other embodiments, QIS 410 scores can be given equal or preferential weighting to QS 408 scores.

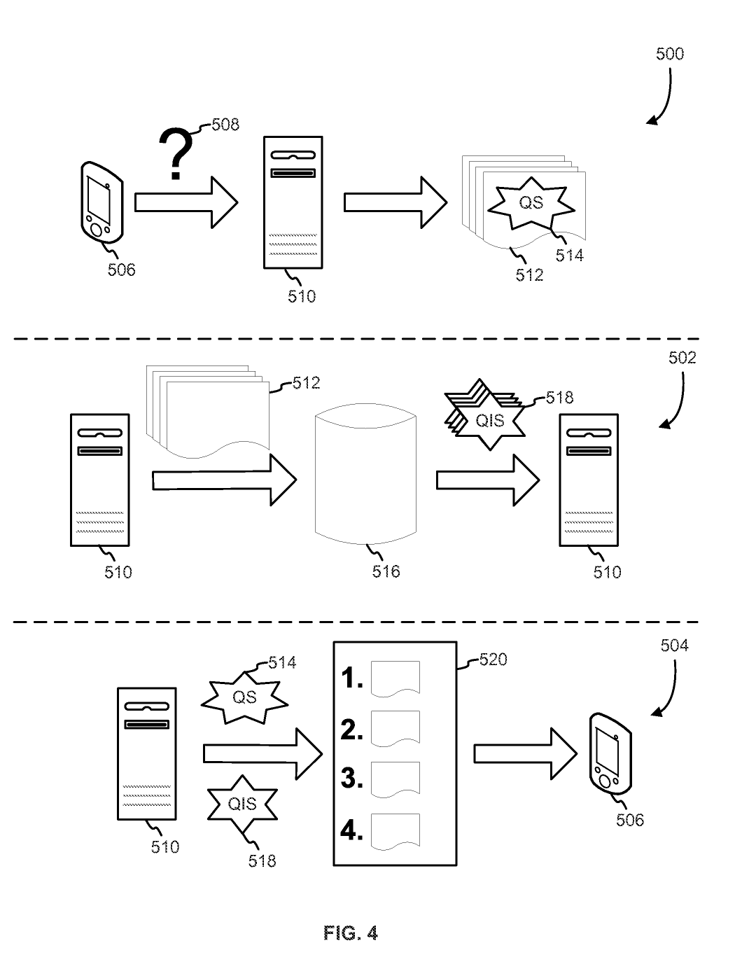

Turning now to FIG. 4, a diagram of communication showing query independent scores applied to search results is shown. The communications are shown in operations of processing a query 500, retrieving query independent scores 502 and ranking a set of results 504. During the operations of processing a query, a device, such as a mobile phone 506, sends a query 508 to a server 510 that is part of a query service. The query service processes the query 508 and returns object references 512 to a group of objects and the associated query scores 514. In one embodiment, the query service is Solr™ from the Apache Software Foundation and the query score is a Lucene™ score. During the operations of retrieving query independent scores 502, a server 510 from the query service uses the object references 512 to retrieve query independent scores 518 associated with the object references 512 from a database 516. The server 510 then has the query independent scores 518 available for use. During the operations of ranking a set of results 504, a server 510 from the query service uses the query score 514 and query independent score 518 for each object to form a ranking of object references 520. The ranking of object references 520 is sent to the mobile phone 506 in an appropriate format, such as a search result web page linking to object description pages for each result.

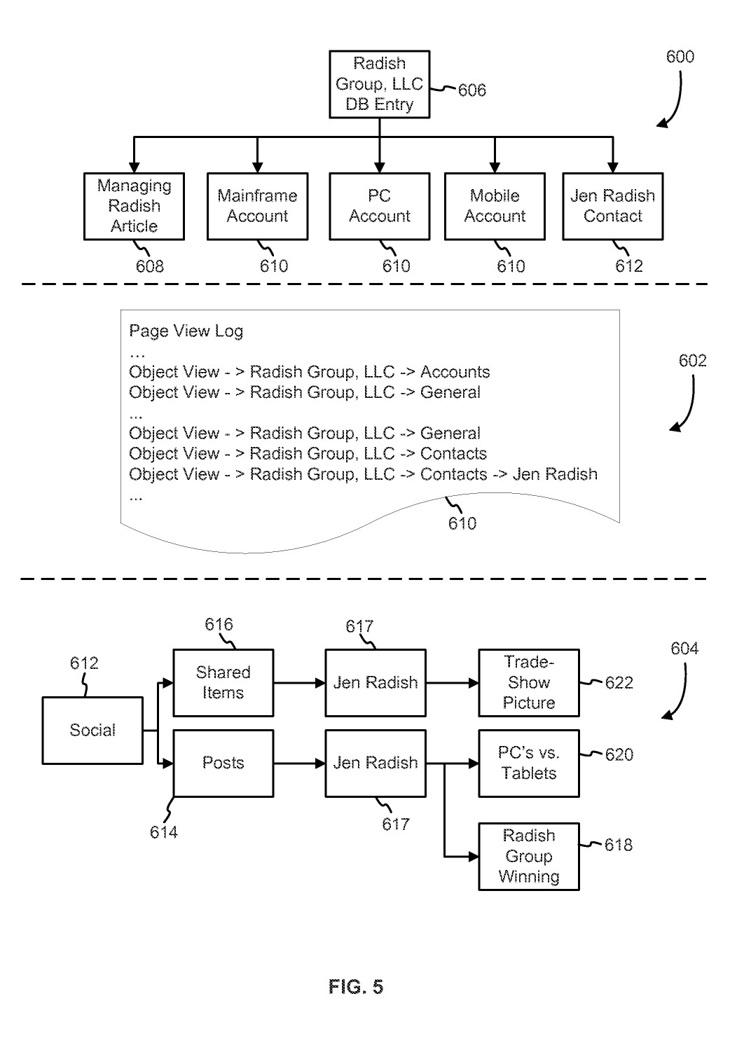

Turning now to FIG. 5, a diagram of information sources for determining user interaction to use in computing query independent scores is shown. Information sources 600, 602, 604 such as database objects, analytics/logs and/or social content are reviewed to determine which information is important. In one embodiment, importance is reflected in a higher query independent score. In an embodiment, information source 600 includes database objects, such as an entity 606, that are reviewed for selected foreign keys representing the number of children of the object. For example, entity 606 has an article 608, three accounts 610 and a contact 612 for the children within the selection of foreign keys. Information source 602 includes analytics and/or log information 610 related to page views. The page views information 610 is compiled and associated with database objects. In some embodiments, page views are double counted as dependent on their access through an object. For example, the Radish Group can be counted as 5 page views and Jen Radish as one page view. In the alternative, the page views can be 4 page views for Radish Group and one page view for Jen Radish, if the page views are to be mapped to only one object. Information source 604 includes social content 612, such as posts 614 and shared content 616. In some embodiments, a query independent scoring system, such as 320 in FIG. 1, reviews posts and shared content for links to an object, discussions about an object or mentions of an object in the database. Links to an object include hyperlinks to an object's display page, discussions underneath the object (such as article 608), authors related to an object (such as a contact of an entity) content tagged as relevant to an object (such as a photograph tagged as a photograph of an entity) and/or other content associated with an object and shared by users. For example, a discussion 618, an article 620 and a picture 622 are counted as shared content for Jen Radish 617 as part of Radish Group in information source 604.

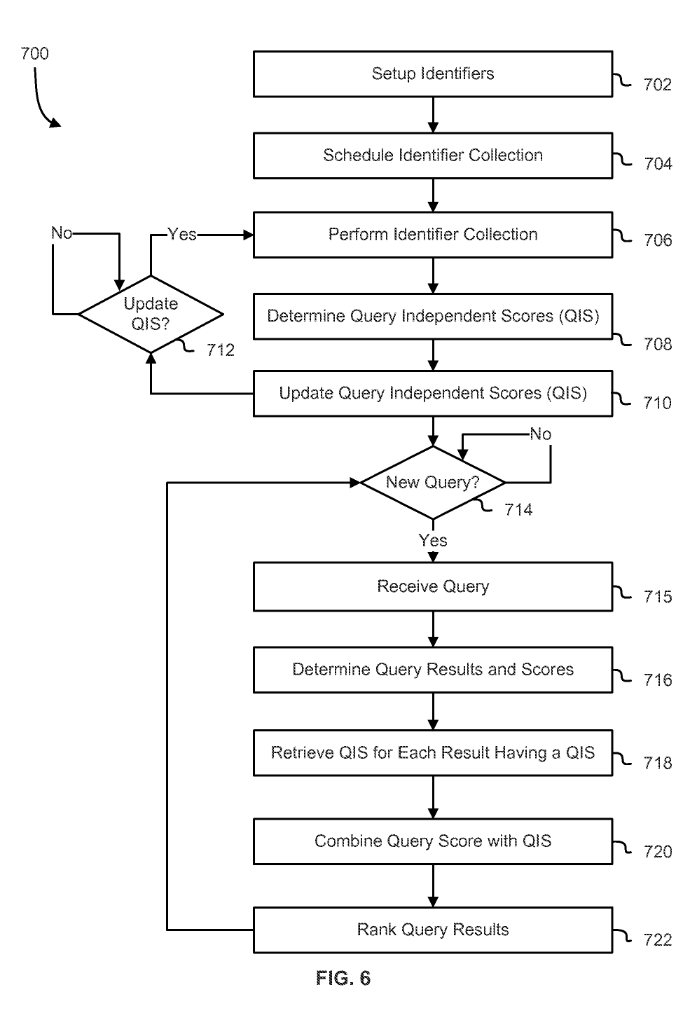

In some embodiments, instead of updating query independent scores as new statistics are formed, query independent scores are updated periodically. A flowchart of a query independent score preparation and application method 700 is shown in FIG. 6. The method 700 can be performed by a server reviewing information in a computing system as part of a service, such as shown in FIG. 2. Query independent score identifiers of objects are selected and setup 702 for gathering from information sources. Identifiers include selected foreign keys, page views and social content. For example, totals of foreign keys, such as contacts and accounts, are identified as foreign key statistics to be counted in the query independent score calculations. Updates to the collection of identifiers are scheduled 704 to be performed periodically. After finishing the setup, statistics of identifiers are gathered. The statistics are used to calculate and determine 708 query independent scores of objects. The query independent scores can then be sent to be used by a new query 714. Updates to query independent scores can be triggered 712 by the schedule or events. For example, if a larger number of page views for an object exceeds a threshold, the object may have its query independent score recalculated and updated for use with new queries.

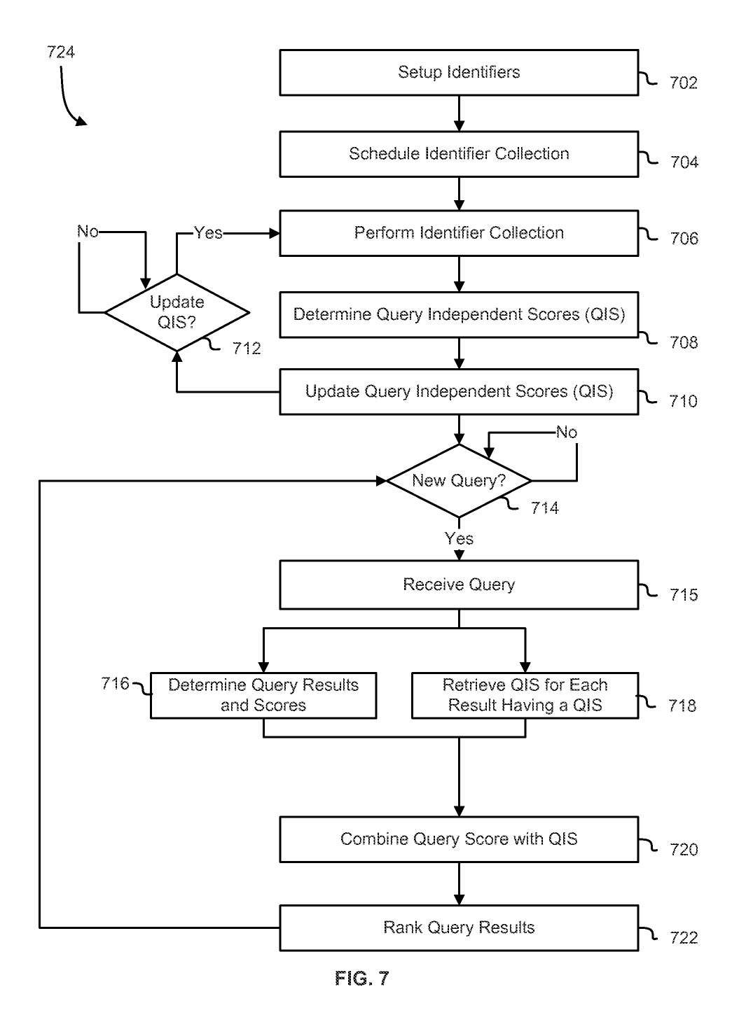

Upon receiving 715 a query, the query is processed to determine 716 search results of objects relating to the query and the associated object query scores. A query may be received directly from a user system (e.g. based on direct user input) or indirectly on behalf of a user system (e.g. based on an automated action). For each object referenced in the search results that has a query independent score, the query independent score is retrieved 718. The query independent score and query score are combined 720 to form a combined score. The combined score is used to rank 722 the results. The results are then sent as an answer to the query. In an embodiment, the results are further processed to display on a webpage on a user's device as seen in FIG. 3. In some embodiments, elements 715, 716, 718 and 720 may be partially or wholly performed in parallel. For example, FIG. 7 shows query independent score pre-fetching. As query independent scores are stored in a database for fully persistent storage, the scores can be also stored in a caching server (such as Memcached) to allow for more efficient retrieval. When the determine 716 query results and scores operation is started, a pre-fetch of all the query independent scores into the caching server is initiated 718 if the query independent scores are not already in the caching server. Thus when operation 716 completes, finishing operation 718 is a very quick and simple retrieve from the caching server to retrieve the query independent scores for the search results.

In an embodiment, only some objects and identifiers are selected to receive query independent scores. Some classes of objects are selected to receive query independent scores because of the perceived importance of the objects. For example, contact objects are selected to receive a query independent score because contacts are frequently searched by users. However, prior address objects are not selected to receive a query independent score because prior address objects are rarely searched or used. Classes of identifiers can be selected as indicators of the importance of an object. For example, the number of accounts within a client indicates the importance of a client. A client with multiple accounts can indicate a larger and potentially more important client. The underlying identifier is the number of foreign keys in an account field under a client. However, not all fields are selected as identifiers. Other fields can be ignored, such as past addresses, as the field is not likely an indicator of importance and therefore not used as an identifier.

In some embodiments, negative indicators can also be used to calculate a query independent score. A negative indicator is used to reduce the query independent result score. For example, an object representing a potential client can have its query result score decreased because of a higher number of attempted contacts that have been rebuffed. In an embodiment, the query independent score is not allowed to go lower than zero. In another embodiment, the query independent score is allowed to go negative and further reduce the query score.

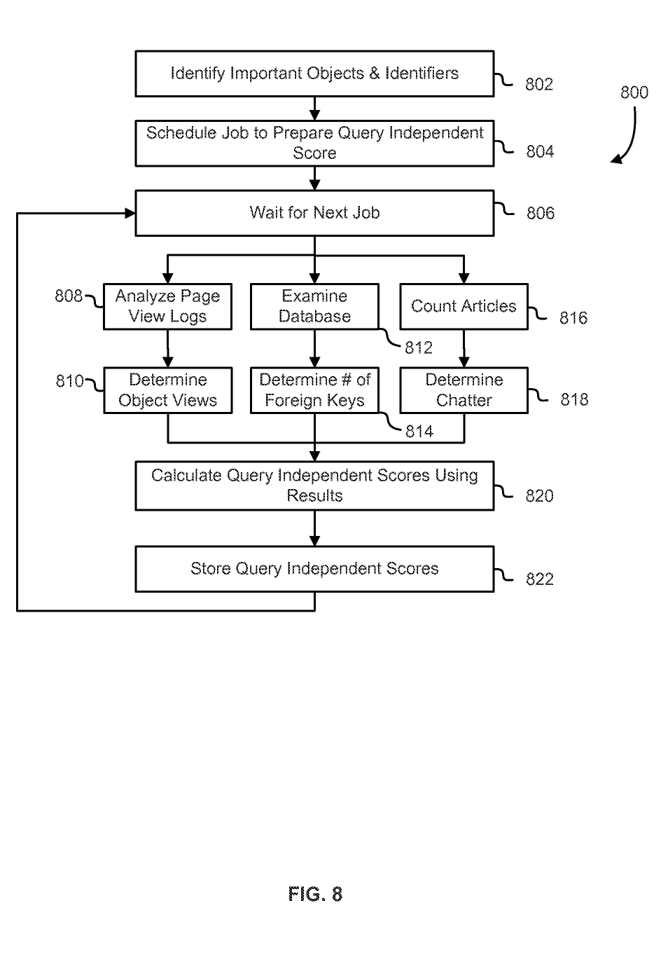

Turning now to FIG. 8, a parallel query independent score preparation method 800 is shown. The method 800 may be performed by a query independent ranking system server as seen in FIG. 2. Important objects are selected 802 to receive query independent scores. Identifiers related to the important objects are selected 802 to provide at least part of the calculation to determine the query independent scores. A job, such as a cron job, is scheduled 804 to gather identifier statistics and calculate the query independent scores. The system may wait 806 for the next job, if an immediate calculation is not requested. An advantage of scheduling the job is that the gathering of information can tax the production database during a low usage time rather than during a high use time. The job can cause multiple information sources to be processed in parallel, and also multiple portions of information sources in parallel. In the embodiment shown, the page view logs are analyzed 808 in parallel with the database identifiers review 812 and article counting 816. Depending on the size of the dataset, the job may use Map/Reduce functionality to process portions of an information set in parallel. For example, page view logs can be of substantial size for a service processing millions of transactions. In an embodiment, large page view logs are analyzed by a cluster of computing resources using a Map/Reduce methodology. In an embodiment, only a certain number of objects will have associated page views stored. The examination of the database determines 814 statistics of selected foreign keys. The examination of articles determines 818 an amount of social chatter, such as a count of articles and shared content. Upon completion of the gathering of the identifier statistics, query independent scores are calculated 820. The query independent scores are then stored 822.

Query independent scores can be calculated using multiple different ways. In one embodiment, the ranking formula is a*number_of_children+b*page_views+c*query_score, where a*number_of_children+b*page_views is pre-calculated and a, b and c are weights. The weights can be selected based on the perceived importance of each unit of measure. In another embodiment, a bloom filter is used. The bloom filter is used to weight a range of values similarly. For example, number_of_children is divided into classes of: few_children, lots_of_children, and ludicrous_amount_of_children. Each range is given a constant that is used in the ranking formula. All objects falling into the few_children class receive the constant for the few_children category. In an embodiment, the ranges are selected by magnitude. An advantage of bloom filter use is only membership of a category need be stored rather than the statistic. Another advantage of the bloom filter is that ranges are treated similarly.

Query independent scores can also be calculated to reflect recency, freshness and popularity. In an embodiment, recency is determined by tracking multiple statistic date windows. Prior windows are weighted lower than current windows. In an embodiment, the recency of an interaction determines the weighting of a statistic. For example, if a child has recently been added to the object, a weighting applied to the number of children statistic of the object is increased. An article read 100 times in the past day is more valuable than an article read 1 time in the last day or 100 times last month. In an embodiment, a simple recency statistic is calculated by applying a decay value to the prior statistic and adding the current statistic. For example, the prior page view statistic is multiplied by 0.9 to form a decayed value. The current page views value is added to the decayed value to form the popularity. Other fields can be used to indicate freshness, such as last modified, last effective modified date, last activity date, close date, creation date, last viewed date and other date columns. In an embodiment, popularity is determined by the number of new or unique accesses to an object. This includes origin, tokens identifying a user and bookmarks added.

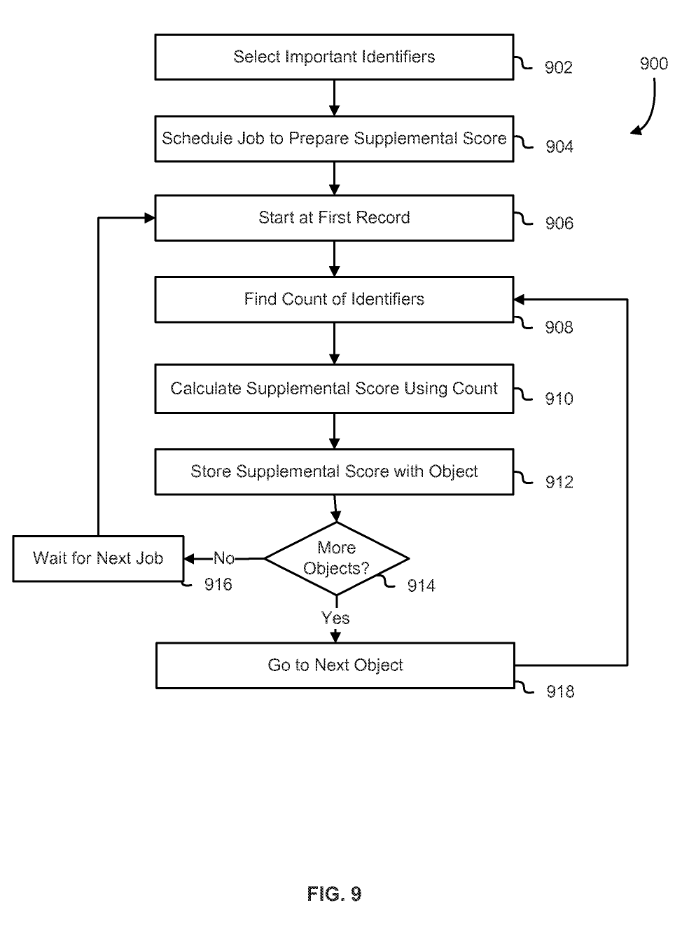

The processing of identifiers can be in series, as well. In FIG. 9, a serial query independent score preparation method 900 is shown. Using selected identifiers 902 and a job schedule 904, the first record can be examined 906. Counts of identifiers in the record are determined 908. A supplemental statistic is calculated 910 and the result is stored as related to the object record 912. If more objects exist to be processed 914, the next object is selected 918 and processed starting at block 908. Otherwise, the processing is complete and the system may await 916 the start of the next job.

In an embodiment, the information sources are separated into smaller portions. The smaller portions are processed together in parallel as seen in FIG. 8 (subject to limitations of available computing resources), but each smaller portion is processed serially as seen in FIG. 9. For example, object tables may be separated into chunks for analysis. Database partitioning can also be used in the determination of chunks. Each chunk is distributed to computing resources for processing as resources are available. Each chunk is processed after distribution by serially analyzing indicators relating to each database object. The resulting statistics can be returned and/or stored with the object. The statistics are also used to calculate query independent result scores which can also be stored with the object.

In another example of parallel and serial processing of an embodiment, a log of object accesses is separated into chunks of a certain length. Each chunk is distributed to computing resources for processing as resources are available. Each chunk is processed after distribution by serially analyzing each page view record. The resulting mapping of objects to accesses is returned for evaluation. After the chunks have been processed and the results combined, the resulting statistics can be returned and/or stored with the object. The statistics are also used to calculate query independent result scores which can also be stored with the object.

While discussion has centered around a single organization, multiple organizations may also be analyzed using the disclosed procedure. For example, in a multi-tenant database, the object statistics can be applied only to an organization. Each organization would have a certain limit of objects that include page views. Thus, an organization with a large number of page views would not dominate the use of resources (such as only calculating a query result score for a certain number of top objects) over a smaller organization.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

What is claimed is:

1. A computer-implemented method for providing search ranking services, comprising:
under the control of one or more computer systems configured with executable instructions,
receiving a search query;
preparing a first search result list based at least in part on the search query, the first search result list having a set of objects, each object having a base score, the base score having been computed based at least in part on the relevance of the object to the query;
for each object of at least a subset of the set of the objects:
(i) retrieving a boost score for the object, the boost score having been computed based at least in part on prior user interactions with the object, the prior user interactions including page views involving the object and a measurement of children beneath the object; and
(ii) joining the base score with the boost score to form a combined score;
ranking the set of object results based on the combined scores; and
returning a ranked set of object results.

2. The computer-implemented method of claim 1, wherein the objects are stored within a database.

3. The computer-implemented method of claim 2, wherein the prior user interactions with an object are measured by number of children of an object.

4. The computer-implemented method of claim 3, wherein the number of children of an object are measured by selected groups of foreign keys.

5. The computer-implemented method of claim 2, wherein the prior user interactions with an object are measured by page views involving an object.

6. The computer-implemented method of claim 2, wherein the prior user interactions with an object are measured by a count of user shared content.

7. A computer-implemented method for providing search ranking services, comprising:
under the control of one or more computer systems configured with executable instructions,
receiving a search query;
retrieving a first search result list based on terms within the search query, the first search result list having a set of objects, each object having a query score, the query score having been computed based at least in part on the association of the object with the query;
for each object of at least a subset of the set of the objects:
(i) retrieving a query independent score associated with the object, the query independent score having been computed based at least in part on prior interactions with the object; and
(ii) joining the query score with a query independent score to form a combined score; and
ranking the set of object results based on the combined scores.

8. The computer-implemented method of claim 7, wherein the objects are stored within a multi-tenant database.

9. The computer-implemented method of claim 8, wherein the objects returned are limited to a current tenant, the search query performed by a current tenant.

10. The computer-implemented method of claim 7, wherein the method further includes retrieving the query independent score from a table entry associated with the object in a database.

11. The computer-implemented method of claim 7, wherein the prior interactions are separated into categories, each category having an associated weighting value, the query independent score having been computed based at least in part on a weighting value multiplied by interactions associated with the object.

12. The computer-implemented method of claim 11, wherein at least one category of prior interaction is selected from the group of foreign keys associated with the object, page views associated with the object, or a count of user shared content associated with the object.

13. A computer system for enabling query independent search scores, comprising:
one or more processors; and
memory, including instructions executable by the one or more processors to cause the computer system to at least:
select a set of objects represented in a database to be associated with a query independent score;
for each object in the set of objects:
(i) measure at least one statistic of query independent identifiers, the identifiers being selected statistics of the objects in the database; and
(ii) calculate a query independent score, the query independent score based at least in part on the at least one statistic of identifiers, the query independent score scaled to supplement a search engine ranking system; and
provide the calculated query independent scores to a search engine, the query independent score configured to increase a ranking of an object included in search results.

14. The computer system of claim 13, wherein at least one of the identifiers is selected from a group of children of the object, page views involving the object or user shared content related to the object.

15. The computer system of claim 13, wherein the query independent score includes at least one prior query independent score with a decay, the decay causing the prior query independent score to have a lesser value than an original value of the prior query independent score.

16. The computer system of claim 13, wherein only selected object types receive a query independent score.

17. The computer system of claim 13, wherein the query independent score is stored in the database as related to the object.

18. The computer system of claim 13, wherein an object is selected to receive an updated query independent score when the change in identifiers exceeds a threshold.

19. One or more non-transitory computer-readable storage media having collectively stored thereon executable instructions that, when executed by one or more processors of a computer system, cause the computer system to at least:
receive a search query;
retrieve a first search result list based on terms within the search query, the first search result list having a set of objects, each object having a query score, the query score having been computed based at least in part on the association of the object with the query;
for each object of at least a subset of the set of the objects:
(i) retrieve a query independent score associated with the object, the query independent score having been computed based at least in part on prior interactions with the object; and
(ii) join the query score with a query independent score to form a combined score; and
rank the set of object results based on combined score.

20. The non-transitory computer-readable storage media of claim 19, wherein the objects are stored within a multi-tenant database.

21. The non-transitory computer-readable storage media of claim 19, wherein the query independent score is stored as metadata.

22. The non-transitory computer-readable storage media of claim 19, wherein each of the prior interactions are measured to form measurements, the query independent score based at least in part on the measurement of prior interactions include a weight to form a part of the query independent score.

23. The non-transitory computer-readable storage media 19, wherein the query independent score is based at least in part on a bloom filter applied to statistics of the prior interactions with the object.

24. The non-transitory computer-readable storage media 19, wherein the instructions further include:
receiving the search query from a user system; and
returning the set of object results to the user system.
